(19) United States
(12) Patent Application Publication
(10) Pub. No.: US 2026/0121289 A1
(43) Pub. Date: Apr. 30, 2026

(54) MULTI-FUNCTIONAL LINK ASSEMBLY FOR SMALL CELL BASE STATION ANTENNA APPARATUS

(71) Applicant: KMW INC., Hwaseong-si (KR)

(72) Inventors: Duk Yong KIM, Yongin-si (KR); Kyo Sung JI, Hwaseong-si (KR); Hee KIM, Osan-si (KR); Chi Back RYU, Hwaseong-si (KR); Won Jun PARK, Yongin-si (KR); Min Sik PARK, Hwaseong-si (KR)

(73) Assignee: KMW INC., Hwaseong-si (KR)

(21) Appl. No.: 19/023,176

(22) Filed: Jan. 15, 2025

Related U.S. Application Data
(63) Continuation of application No. PCT/KR2023/009362, filed on Jul. 4, 2023.

(30) Foreign Application Priority Data
Jul. 20, 2022 (KR) 10-2022-0089598
Jun. 29, 2023 (KR) 10-2023-0084083

(51) Int. Cl. H01Q 3/08; H01Q 1/24

(52) U.S. Cl. CPC H01Q 3/08; H01Q 1/246

(57) ABSTRACT

The present disclosure relates to a small base station antenna apparatus comprising, particularly, a fixed housing having an internal space open in one direction and the other direction, and a directivity adjustment means movably coupled to the internal space of the fixed housing or an external space corresponding to the outside thereof, wherein the directivity adjustment means is coupled to the fixed housing such that it is caught when an antenna module provided at the front end portion is rotationally steered left or right or rotationally tilted up or down, and thus is prevented from being separated. Accordingly, the advantages of improving the workability of indoor installation as well as facilitating building of a small cell base station are provided.

### TECHNICAL FIELD

The present disclosure relates to a multi-functional link assembly for a small base station antenna apparatus, and more particularly, to a multi-functional link assembly for a small base station antenna apparatus that prevents external exposure of cables, easily builds an indoor small cell, and enables beam forming to implement multi-bands by dividing a portion of one antenna module to cover different frequency bands or by providing a plurality of antenna modules to cover different frequency bands, respectively.

### BACKGROUND ART

In order to meet the demand for wireless data traffic since the 4G communication system came to the market, there are ongoing efforts to develop enhanced 5G communication systems or pre-5G communication systems. For the reasons, the 5G communication system or pre-5G communication system is called the beyond 4G network communication system or post LTE system. In order to achieve a high data transmission rate, the 5G communication system is being considered for implementation in a very high frequency (mmWave) band (for example, a 60 gigahertz (60 GHz) band, etc.). In order to alleviate a path loss of radio waves and increase a propagation distance of radio waves in the very high frequency band, in the 5G communication system, beamforming, massive MIMO, and full dimensional MIMO (FD-MIMO), an array antenna, analog beam-forming, and large scale antenna technologies are being discussed.

In particular, in the future 5G cellular network that requires much higher capacity than the current capacity, various technologies that increase frequency efficiency can be applied. Small cell network (SCN) technology, which is one of several technology candidates, may increase channel utility by miniaturizing the size of cells to increase frequency efficiency and increase capacity by increasing cell density.

Unlike the existing macro cell that has high transmission power and wide coverage, the small cell is a small base station that has narrow coverage with low transmission power. The category of the small cells collectively refers to low-power base station equipment of 10 W or less, pico cells, femto cells, Wi-Fi, etc. The advantages of the small cells are that they cost less to build and are smaller than macro cells, which may increase space efficiency.

When these small cells are confirmed to overlap in public spaces, densely populated areas, and indoor spaces such as large shopping malls or airport buildings, the capacity per unit area may be increased. This also has the advantage of reducing the power consumed by one macro cell base station and the installation costs. Since only the small cell base stations can achieve a capacity 1,000 times higher than that of the existing LTE, the small cells are expected to become the basic technology connecting 4G and 5G.

The antenna device for a base station according to the conventional embodiment is installed outdoors, and an antenna module is mounted on an upright support pole by a fixed bracket, and a radio unit (e.g., remote radio head (RRH)) is mounted on a lower side of the antenna module by a fixed bracket, and a plurality of cables are used between the antenna module and the radio unit.

However, the conventional antenna device for a base station has a structure that is limited to outdoor (outdoor) installation by installing it through a support pole, and since it is composed of the structure in which the antenna module is mounted on a relatively upper side of the support pole and the radio unit, such as the RRH, is mounted on a relatively lower side, and then connected using a cable, there is a problem in that the cable is exposed to the outside and deteriorates the appearance.

In this way, when the small cell base station is installed indoors, there is a problem in that the appearance deteriorates due to the complex cable connection between the radio unit (RRH) and the antenna module, and since only one antenna module is equipped for each radio unit (RRH), there is a problem in that it is difficult to realistically cover a dual-band frequency band.

### DISCLOSURE

### Technical Problem

The present disclosure provides a multi-functional link assembly for a small base station antenna apparatus that easily builds a small cell base station in places such as public places, densely populated areas, large shopping malls, and empty buildings.

The present disclosure provides multi-functional link assembly for a small base station antenna apparatus capable of preventing an appearance from deteriorating by adjusting directivity of various cables electrically connecting between a radio unit and an antenna module without being exposed to the outside.

The present disclosure provides a multi-functional link assembly for a small base station antenna apparatus capable of implementing dual band at various locations by dividing a portion of a single antenna module to cover different frequency bands or by providing each of the plurality of antenna modules to cover different frequency bands.

The present disclosure provides a multi-functional link assembly for a small base station antenna apparatus capable of mediating the installation of a plurality of antenna modules to a radio unit and securing a wide range of directivity adjustment angle.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

### Technical Solution

In one general aspect, a multi-functional link assembly for a small base station antenna apparatus includes: a fixed housing having an internal space open in one direction and the other direction; and a directivity adjustment means movably coupled to the internal space of the fixed housing or an external space corresponding to the outside thereof, in which the directivity adjustment means may be coupled to the fixed housing such that the directivity adjustment means is caught when an antenna module provided at a front end portion is rotationally steered left or right or rotationally tilted up or down, and thus is prevented from being separated.

The antenna module may be coupled in the one direction of the fixed housing via the directivity adjustment means, and a radio unit may be coupled in the other direction of the fixed housing via a cable receiving pipe in which a plurality of coaxial cables are hidden and received.

A pair of housing covers may be manufactured as two pieces and coupled in a form in which an outer component provided relatively on an outer side of the fixed housing and the directivity adjustment means surrounds an inner component.

The directivity adjustment means may move around an arbitrary tilting rotation center point (hereinafter, abbreviated as ‘tilting rotation point’) and an arbitrary steering rotation center point (hereinafter, abbreviated as ‘steering rotation point’) formed in the internal space of the fixed housing, and fix a front surface of the antenna module at a predetermined angle with respect to the radio unit.

The directivity adjustment means may include at least one of: a steering means adjusting the steering rotation of the antenna module while rotating left and right around a steering rotation point provided in an up-down direction via the fixed housing; and a tilting means adjusting the tilting rotation point of the antenna module while tilting and rotating in a front and rear direction around the tilting rotation point provided in a left-right direction via the fixed housing.

The directivity adjustment means may include the steering means and the tilting means, and the steering means and the tilting means may be integrated into a ball joint part that is partially inserted and rotated between a one-sided housing cover and the other-sided housing cover of the fixed housing manufactured in two pieces.

A friction stopper ring that prevents the separation of the ball joint part and is in close contact with a friction sealing member formed on an outer circumferential surface of the ball joint part may be interposed between the one-sided housing cover and the other-sided housing cover.

The directivity adjustment means may include the tilting means, and the tilting means may include an inner joint that is partially inserted and rotated between a one-sided housing cover and the other-sided housing cover of the fixed housing manufactured in two pieces.

The one-sided housing cover of the fixed housing may be an upper housing cover positioned relatively higher, and the other-sided housing cover of the fixed housing may be a lower housing cover positioned relatively lower.

One end portion of the cable receiving pipe may be orthogonally connected to a rear end portion of the fixed housing, and the other end portion of the cable receiving pipe may be connected to the radio unit, and the fixed housing may be connected such that the front end portion steering-rotates in the left-right direction based on a center of the cable receiving pipe.

The directivity adjustment means may include the steering means and the tilting means, the steering means may include a steering installation part rotationally installed in the internal space of the fixed housing in the left-right direction based on the steering rotation point, and a steering rotation part extending from the steering installation part to the external space outside the fixed housing, and the tilting means may include a one-sided tilting housing cover provided to cover the steering rotation part from one side to the other side, and the other-sided tilting housing cover shielding the open other side of the one-sided tilting housing cover.

The directivity adjustment means may further include: a steering friction force forming pad arranged between the steering installation part of the steering means and the fixed housing; and a tilting friction force forming pad arranged between the one-sided tilting housing cover of the tilting means and the steering rotation part of the steering means, and a plurality of friction ribs extending radially to a predetermined length based on the steering rotation point and the tilting rotation point are formed protruding on an inner side surface of the fixed housing in contact with both surfaces of the steering friction force forming pad and the tilting friction force forming pad, an outer side surface of the steering installation part, and an inner side surface of the one-sided tilting housing cover of the tilting means.

A plurality of coaxial cables electrically connecting the radio unit and the antenna module may be provided to be installable in an internal space between a rear end of the steering installation part and a front end of a steering rotation part, a steering guide hole may be formed in the front end portion of the fixed housing through which the plurality of coaxial cables penetrate and which limits a steering angle of the steering means in the left-right direction, and a tilting guide hole through which the plurality of coaxial cables penetrate and which limits a steering angle of the steering means in front and rear directions may be formed in a rear end portion of the one-sided tilting housing cover of the tilting means.

After the steering angle is adjusted within a range of the steering guide hole, the steering means may be fixed by a steering fixing bolt fastened to the fixed housing.

After the tilting angle is adjusted within a range of the tilting guide hole, the tilting means may be fixed by a tilting fixing bolt fastened to the one-sided tilting housing cover.

### Advantageous Effects

According to a multi-functional link assembly for a small base station antenna apparatus according to an embodiment of the present disclosure, the following various effects can be derived.
First, since an antenna module can be easily adjusted in directivity even in a narrow space, it is possible to easily build a small cell base station.
Second, by adjusting directivity of various cables electrically connecting between a radio unit and an antenna module without being exposed to the outside, it is possible to prevent an appearance from deteriorating.
Third, since a tilting ball joint and a steering ball joint can be compactly installed without securing additional installation space, and angle adjustment is possible through each ball joint, it is possible to secure a wide range of directivity adjustment angles of a plurality of antenna modules for a radio unit.

### BRIEF DESCRIPTION OF THE DRAWINGS

FIG. 1 is a perspective view illustrating an installation appearance of an antenna module for a radio unit using a multi-functional link assembly for a small base station antenna apparatus according to a first embodiment of the present disclosure.

FIGS. 2A and 2B are perspective views of front and rear portions of a configuration of FIG. 1, excluding the radio unit.

FIGS. 3A and 3B are exploded perspective views of FIGS. 2A and 2B.

FIG. 4 is a cross-sectional view and a cut-away perspective view taken along the line B-B of FIG. 2A.

FIGS. 5A and 5B are front and rear perspective views illustrating a multi-functional link assembly for a small base station antenna apparatus according to a second embodiment of the present disclosure.

FIGS. 6A and 6B are exploded perspective views of FIGS. 5A and 5B.

FIG. 7 is a cross-sectional view and a cut-away perspective view taken along the line C-C of FIG. 5A.

FIG. 8 is a perspective view illustrating a multi-functional link assembly for a small base station antenna apparatus according to a third embodiment of the present disclosure.

FIGS. 9A and 9B are exploded perspective views of FIG. 8.

<Description of Reference Signs>

| | |
|---|---|
| A: Antenna module | RRH: Radio unit |
| 10: Mounting bracket | 12: Screw fastening groove |
| 13: Fixing screw | 15: Heat sink fin |
| 100: First embodiment | 110: Fixed housing |
| 110A, 110B: Housing cover | 113A-h: Assembly screw through hole |
| 113B-h: Assembly screw fastening hole | 115: Assembly screw |
| 130: Ball joint part | 131: Outer support part |
| 132: Inner joint | 140: Friction stopper ring |
| 150: Cable receiving pipe | 160: Multi-strand coaxial cable |
| 180A: Antenna side fastening nut | 180R: Radio unit side fixing nut |
| 200: Second embodiment | 300: Third embodiment |

### BEST MODE

Hereinafter, a multi-functional link assembly for a small base station antenna apparatus according to various embodiments of the present disclosure will be described in detail with reference to the accompanying drawings.

It is to be noted that in giving reference numerals to components of each of the accompanying drawings, the same components will be denoted by the same reference numerals even though they are illustrated in different drawings. Further, in describing exemplary embodiments of the present disclosure, well-known constructions or functions will not be described in detail in the case in which it is decided that they may unnecessarily obscure the understanding of exemplary embodiments of the present disclosure.

Terms ‘first’, ‘second’, A, B, A, (b), and the like, will be used in describing components of exemplary embodiments of the present disclosure. These terms are used only in order to distinguish any component from other components, and features, sequences, or the like, of corresponding components are not limited by these terms. In addition, unless defined otherwise, all the terms used in the present specification, including technical and scientific terms, have the same meanings as meanings that are generally understood by those skilled in the art to which the present disclosure pertains. It should be interpreted that terms defined by a generally used dictionary are identical with the meanings within the context of the related art, and they should not be ideally or excessively formally interpreted unless the context clearly dictates otherwise.

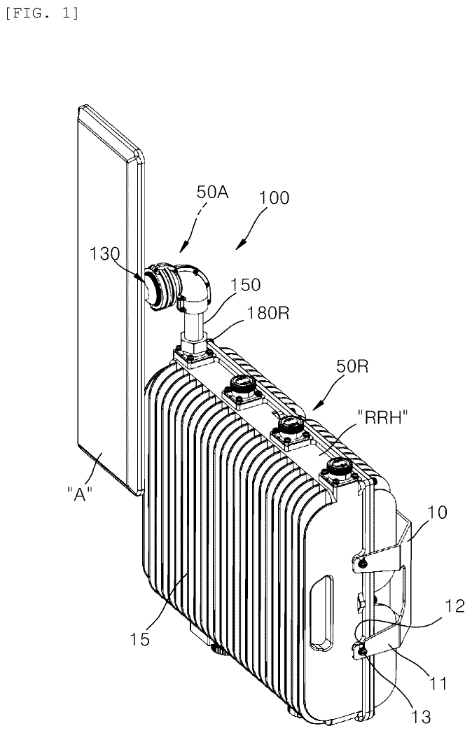

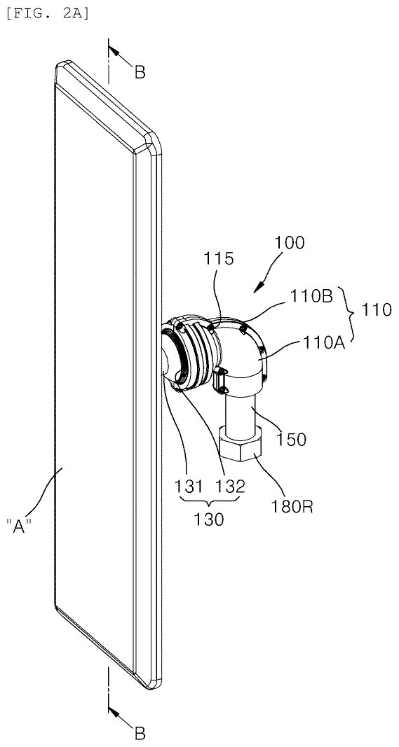

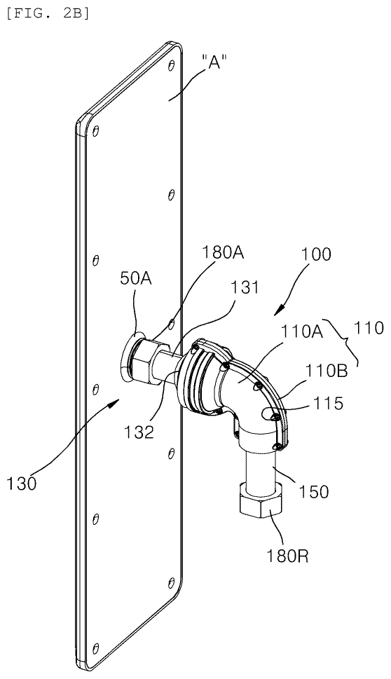

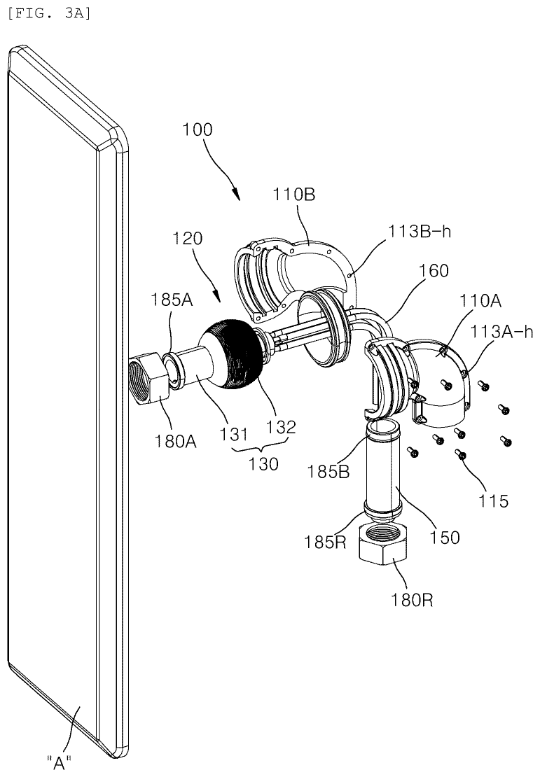

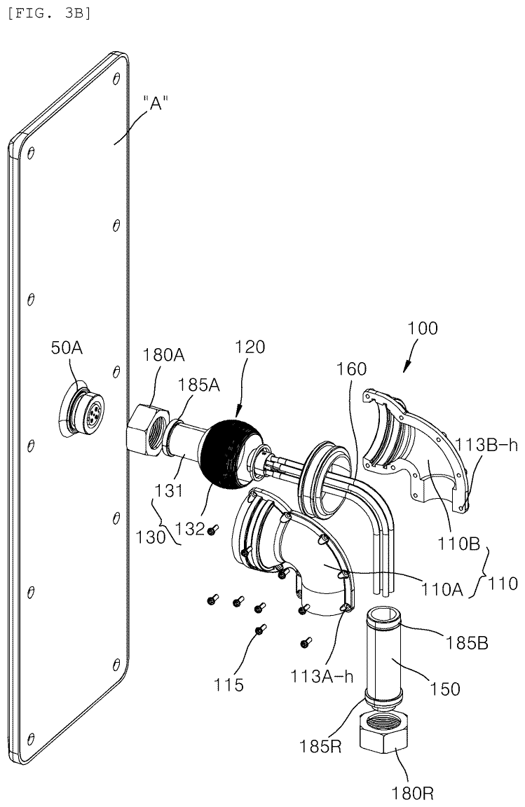

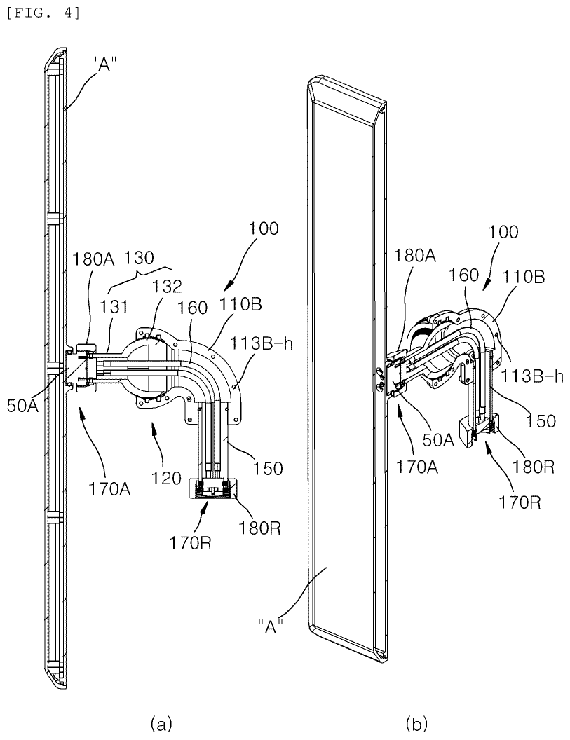

FIG. 1 is a perspective view illustrating an installation appearance of an antenna module for a radio unit using a multi-functional link assembly for a small base station antenna apparatus according to a first embodiment of the present disclosure, FIGS. 2A and 2B are perspective views of front and rear portions of a configuration of FIG. 1, excluding the radio unit, FIGS. 3A and 3B are exploded perspective views of FIGS. 2A and 2B, and FIG. 4 is a cross-sectional view and a cut-away perspective view taken along the line B-B of FIG. 2A.

Multi-functional link assemblies 100 to 300 for a small base station antenna apparatus according to embodiments of the present disclosure may perform a role of mediating a physical connection between a radio unit (remote radio head (RRH) of a configuration of a small base station antenna apparatus installed at a predetermined location and at least one (a plurality of) antenna modules A coupled thereto.

In addition, the radio unit (RRH) and the plurality of antenna modules A may be electrically connected via multi-strand coaxial cables 160, 260, and 360 that are installed in a hidden manner by the multi-functional link assemblies 100 to 300 for a small base station antenna apparatus according to embodiments of the present disclosure.

Here, the predetermined location where the small base station antenna apparatus according to the present disclosure is installed means a public place, a densely populated area, a large shopping mall, an airport building, etc., so as to perform a function as a small cell base station, and depending on the type of installation, it may be a structure suitable for in-building (indoor) installation, such as a pole-mounted type, a wall-mounted type, and a ceiling-mounted type.

The antenna module A may refer to an antenna module having at least one frequency band. In addition, the radio unit (RRH) may mean a device that is connected to each frequency band-specific antenna provided to the antenna module A and performs transmission/reception between the antenna and the base station. The radio unit (RRH) is a relay device that receives a weakened signal and performs functions such as amplifying or retransmitting the weakened signal, standardizing a distorted waveform, and readjusting timing between a base station and a mobile communication terminal of a mobile communication system.

Among the components of the small base station antenna apparatus, the radio unit (RRH) may be mounted on structures such as a support pole, a wall, and a ceiling of an indoor (house) using mounting bracket 10 as a medium, as illustrated in FIG. 1.

To this end, the mounting bracket 10 may be fixed to multiple locations on both left and right end portions of the radio unit (RRH) by using a fixing screw 13 through a screw fixing groove 12 formed on a screw fixing end 11 that protrudes left/right and forward to be bent while being firmly connected to the structures described above in advance.

Meanwhile, a plurality of heat sink fins 15 are integrally formed on a front surface of the front housing (reference numeral not indicated) or a rear surface of a rear housing (reference numeral not indicated) of the radio unit (RRH), so that heat generated in a predetermined space may be dissipated to the outside through the plurality of heat sink fins 15.

In this way, the multi-functional link assemblies 100 to 300 for a small base station antenna apparatus according to the embodiments of the present disclosure performs the role of mediating the coupling of at least one antenna module A to the radio unit (RRH).

That is, at least one female connector 50A and 50R, which mediates the connection with the multi-functional link assembly 100 for a small base station antenna apparatus according to an embodiment of the present disclosure, may be provided on one portion of the radio unit (RRH) and one portion of each of one or more antenna modules A, respectively.

Here, the female connector 50R provided on the radio unit (RRH) may be disposed on a portion where some of the plurality of heat sink fins 15 integrally formed on the front surface or rear surface of the radio unit (RRH) are deleted, and may also be disposed on any of the left and right side surfaces and a lower surface.

However, in the multi-functional link assembly 100 for a small base station antenna apparatus according to an embodiment of the present disclosure, as referenced in FIGS. 1 to 2B, it will be described assuming that the female connector 50R is disposed on an upper surface of the radio unit (RRH).

Meanwhile, the multi-functional link assemblies 100 to 300 for a small base station antenna apparatus according to embodiments of the present disclosure may include a fixed housing 110R disposed between the radio unit (RRH) and the antenna module A and a directivity adjustment means 120 that is movably coupled to the inside or outside of the fixed housing 110R but moves around a tilting rotation point or a steering rotation point to fix a front surface of the antenna module A at a predetermined angle with respect to the radio unit (RRH).

Referring to FIGS. 3A and 3B, the fixed housing 110R may be formed to have an internal space that is open in one direction (e.g., the front where the antenna module A is installed) and the other direction (e.g., the rear where the radio unit (RRH) is installed).

Meanwhile, the directivity adjustment means 120 may be movably coupled to the internal space of the fixed housing 110R or the external space corresponding to the outside thereof.

In this case, the directivity adjustment means 120 may be coupled to the fixed housing 110R such that the directivity adjustment means is caught when the antenna module A provided at a front end portion is rotationally steered left or right or rotationally tilted up or down, and thus is prevented from being separated.

In one direction of the fixed housing 110R, the antenna module A may be coupled via the directivity adjustment means 120. In addition, as described below, in the other direction of the fixed housing 110R, the radio unit (RRH) may be coupled via the cable receiving pipe 150 in which the multi-strand coaxial cable 160 is hidden and received.

The directivity adjustment means 120 having such a configuration may move around an arbitrary tilting rotation center point (hereinafter, abbreviated as ‘tilting rotation point’) and an arbitrary steering rotation center point (hereinafter, abbreviated as ‘steering rotation point’) formed in the internal space of the fixed housing 110R, and may be fixed at a predetermined angle to the front surface of the antenna module A with respect to the radio unit (RRH).

Here, the outer component provided relatively on the outer side of the fixed housing 110 and the directivity adjustment means 120 may include a pair of housing covers (for example, 110A and 110B in the case of a second embodiment, 210D and 210U in the case of a third embodiment, 330 and 333 and 340 and 343) manufactured and combined in a form that surrounds the inner component.

Hereinafter, the multi-functional link assembly for a small base station antenna apparatus according to the present disclosure will be described in detail in the order of embodiments.

The multi-functional link assembly 100 for a small base station antenna apparatus according to the first embodiment of the present disclosure includes the directivity adjustment means 120 as referenced in FIGS. 1 to 4.

Here, the directivity adjustment means 120 includes the steering means and the tilting means described above, but the steering means and the tilting means may be integrated into a ball joint part 130 that is partially inserted and rotated between the one-sided housing cover 110A and the other-sided housing cover 110B of the fixed housing 110R manufactured in two pieces.

For example, referring to in FIGS. 1 to 4, a portion corresponding to an inner joint 132 of the ball joint part 130 is caught to a front end portion of the internal space of the fixed housing 110R, and an outer support part 131, which is extended from a front end of the inner joint 132 and is provided to be connected to the antenna module A, adjust the directionality of the antenna module A while rotating around the tilting rotation point or the steering rotation point formed in the internal space of the fixed housing 110R.

In this way, when the ball joint part 130 is installed in the internal space of the fixed housing 110R, the portion corresponding to the inner joint 132 is combined in a form in which it is caught during the left-right steering rotation or up-down tilting rotation and thus is prevented from being separated.

The fixed housing 110R is provided to be bent to have an internal space having a roughly ‘¬’ shape, and may include the one-sided housing cover 110A forming a right appearance in the drawing, and the other-sided housing cover 110B forming a left appearance in the drawing.

A plurality of assembly screw penetration holes 113A-h and assembly screw fastening holes 113B-h, through which a plurality of fixed housing assembly screws 115 are penetrated and fastened, are respectively formed spaced apart from each other at edge end portions of the one-sided housing cover 110A and the other-sided housing cover 110B, and when the one-sided housing cover 110A and the other-sided housing cover 110B form an internal space while the plurality of fixed housing assembly screws 115 are respectively fastened through the plurality of assembly screw penetration holes 113A-h and assembly screw fastening holes 113B-h, the multi-strand coaxial cable 160 may be installed to penetrate through the internal space.

Referring to FIG. 4, the front end portion among both ends of the multi-strand coaxial cable 160 may be provided with an antenna side male connector 170A that is electrically connected to the antenna side female connector 50A provided on the rear surface portion of the antenna module A, and the rear end portion (lower end portion) among both ends of the multi-strand coaxial cable 160 may be provided with a radio unit side male connector 170R that is electrically connected to the radio unit side female connector 50R provided on the radio unit (RRH).

Here, the multi-strand coaxial cable 160 is connected such that the radio unit side male connector 170R is connected to the radio unit side female connector 50R, and the antenna side male connector 170A is connected to the antenna side female connector 50A, and may be hidden and installed so as to penetrate through the internal space of the fixed housing 110R and the inside of the directivity adjustment means 120 provided with the ball joint part 130 so that it may be hidden and installed without being exposed to the outside at all.

Meanwhile, referring to FIGS. 1 to 4, the multi-functional link assembly 100 for a small base station antenna apparatus according to the first embodiment of the present disclosure may further include a cable receiving pipe 150, one end portion of which is connected to the radio unit (RRH) and the other end portion is connected to the fixed housing 110R so that the multi-strand coaxial cable 160 may be received and hidden and installed to be penetrated.

Here, the radio unit side male connector 170R of the multi-strand coaxial cable 160 may be fixed to the inner side of the one end portion of the cable receiving pipe 150, and the antenna side male connector 170A of the multi-strand coaxial cable 160 may be fixed to a tip side of the outer supporter part 131 of the ball joint part 130.

Here, at least one antenna module A may be adjusted for steering rotation in conjunction with the steering rotation angle of the ball joint part 130 in the left-right direction with respect to the fixed housing 110R, and may be adjusted for tilting rotation in conjunction with the tilting rotation angle of the ball joint part 130 in the front-rear direction with respect to the fixed housing 110R.

Meanwhile, a friction stopper ring (reference numeral not indicated) may be interposed between one housing cover 110A and the other housing cover 110B of the fixed housing 110R to prevent the separation of the inner joint 132 of the ball joint part 130 and to come into close contact with a friction sealing member (reference numeral not indicated) formed on an outer circumferential surface of the inner joint 132 of the ball joint part 130.

The friction stopper ring is attached so that a predetermined frictional force is formed on the friction sealing member formed on an outer circumferential surface of the inner joint 132 when the assembly force is transmitted to the one-sided housing cover 110A and the other-sided housing cover 110B using the fixed housing assembly screw 115, thereby preventing the antenna module A from moving due to a natural external force such as wind after the adjustment of the directivity adjustment means 120 equipped with the ball joint part 130.

For example, the friction sealing member is a friction pad made of silicone material applied and adhered to the outer surface of the inner joint 132, and when the one-sided housing cover 110A and the other-sided housing cover 110B are mutually attached by the assembly force by the fixed housing assembly screw 115, the inner surface of the friction stopper ring is in close contact with the outer circumferential surface of the friction sealing member.

A ball joint gasket ring 185A is interposed at a tip of the outer support part 131 of the ball joint part 130, and when the nut is assembled by the antenna side fixing nut 180A, a waterproof function may be performed toward the antenna side female connector 50A side.

In addition, a pipe lower gasket ring 185R is interposed at a lower end portion of the cable receiving pipe 150, and when the nut is assembled by the radio unit side fixing nut 180R, the waterproof function may be performed toward the radio unit side female connector 50R side. Similarly, a pipe upper gasket ring 185B is interposed at an upper end portion of the cable receiving pipe 150, and a waterproof function may be performed at a connection part for the fixed housing 110R of the cable receiving pipe 150.

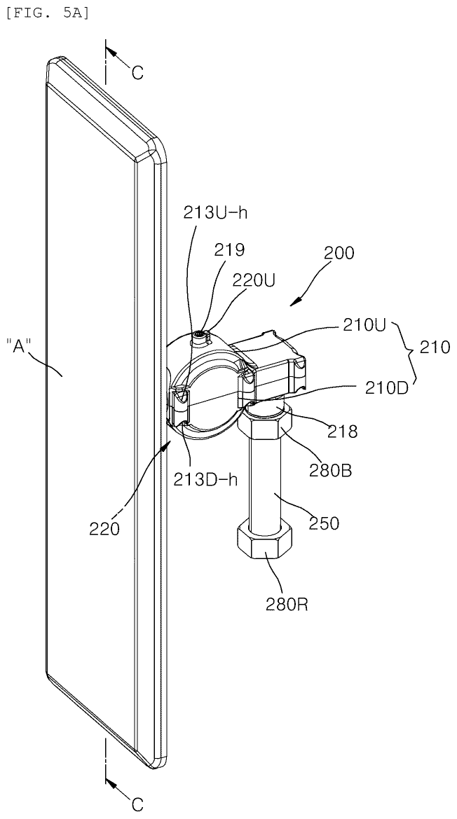

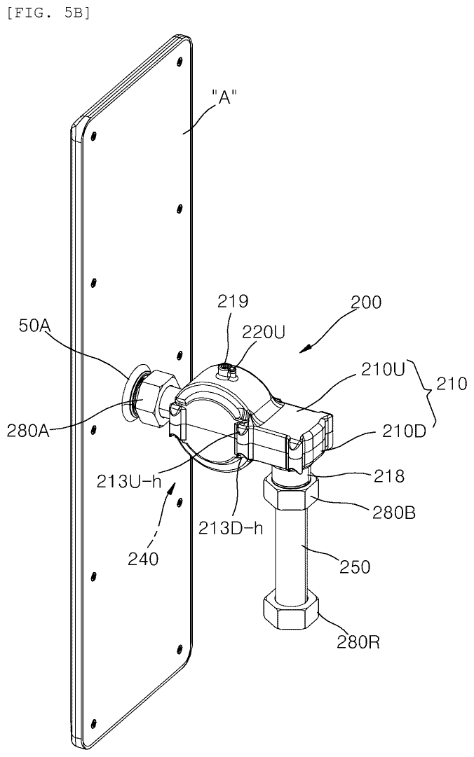

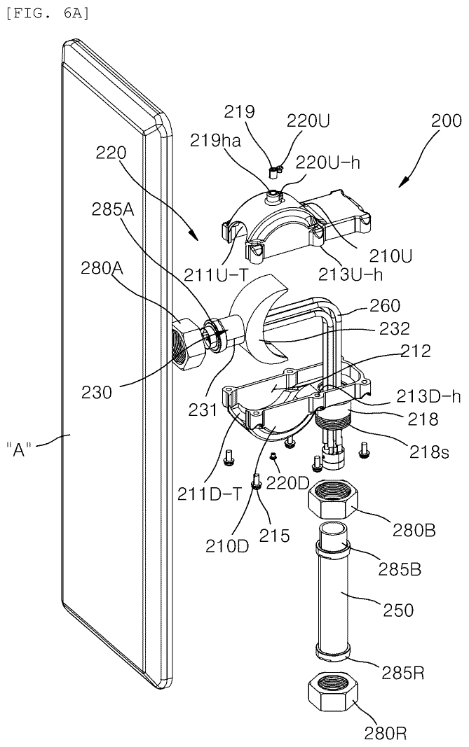

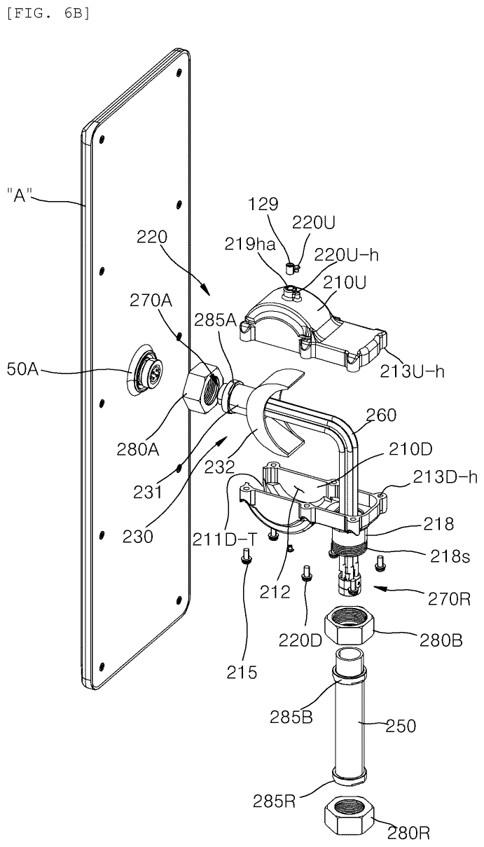

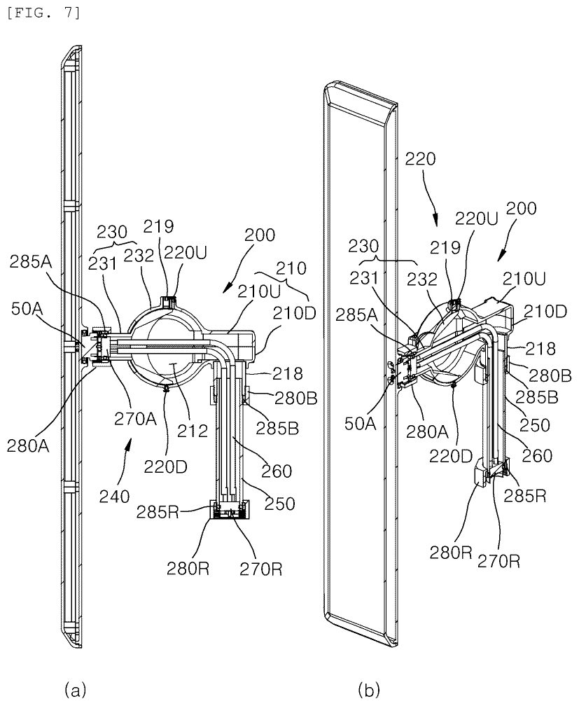

FIGS. 5A and 5B are front and rear perspective views illustrating a multi-functional link assembly for a small base station antenna apparatus according to a second embodiment of the present disclosure, FIGS. 6A and 6B are exploded perspective views of FIGS. 5A and 5B, and FIG. 7 is a cross-sectional view and a cut-away perspective view taken along the line C-C of FIG. 5A.

The multi-functional link assembly 200 for a small base station antenna apparatus according to the second embodiment of the present disclosure may include directivity adjustment means 220 that is composed of only tilting means 230, as referenced in FIGS. 5A to 7.

More specifically, the tilting means 230 may include an inner joint 232 that is partially inserted and rotated between the one-sided housing cover 210U and the other-sided housing cover 210D of the fixed housing 210 manufactured in two pieces, and an outer supporter part 231 that extends from the inner joint 232 and is connected to the antenna side female connector 50A provided on the rear side of the antenna module A.

Here, the one-sided housing cover 210U of the fixed housing 210 may be an upper housing cover positioned relatively higher, and the other-sided housing cover 210D of the fixed housing 210 may be a lower housing cover positioned relatively lower.

Here, the fixed housing 210 may play a role of forming the internal space to accommodate the inner joint 232 among the components of the tilting means 230, as referenced in FIGS. 6A and 6B.

The internal space described above is formed between the upper housing cover, which is the one-sided housing cover 210U, and the lower housing cover, which is the other-sided housing cover 210D, and, among the boundary areas where the one-sided housing cover 210U and the other-sided housing cover 210D are mutually connected, the inner joint 132 may be inserted and received in the front portion, and tilting inlets 211U-T and 211D-T, which provide a tilting rotation range of the tilting means 230, may be formed, respectively.

Here, the multi-functional link assembly 200 for a small base station antenna apparatus according to the second embodiment of the present disclosure has been described as having only the tilting means 230 as the configuration of the directivity adjustment means 220, but the second embodiment 200 may also further include a cable receiving pipe 250. In this case, by adjusting the fixed position of the fixed housing 210 with respect to a pipe connection end 218 formed to extend downwardly of the other housing cover 210D among the fixed housing 210 connected to the cable receiving pipe 250, a practical function such as the steering means among the directivity adjustment means 220 may be implemented.

More specifically, the multi-functional link assembly 200 for a small base station antenna apparatus according to the second embodiment of the present disclosure may further include a cable receiving pipe 260 in which one end portion (upper end portion) is connected to the pipe connection end 218 extending downwardly from the other housing cover 210D of the fixed housing 210 and the other end portion (lower end portion) is connected to the radio unit side female connector 50R provided in the radio unit (RRH), and the plurality of coaxial cables 260 are installed to penetrate through the inside.

Here, a pipe upper gasket ring 285B is interposed at the upper end portion of the cable receiving pipe 260, and when the cable receiving pipe 260 is fastened to a nut fastening end 218s provided in the form of a male thread on the outer circumferential surface of the pipe connecting end 218 in a waterproof manner using the pipe fastening nut 280B, the rotation adjustment and fixation of the antenna module A in the left-right direction may be substantially achieved like the steering means by adjusting the fixing position of the fixed housing 210.

For reference, a pipe lower gasket ring 285R is interposed at the lower end portion of the cable receiving pipe 260, and can also be fastened to the female connector 50R of the radio unit (RRH) in a waterproof manner using a radio unit the side fixing nut 280R.

Meanwhile, it is preferable that the upper and lower tips of the inner joint 232 among the components of the tilting means 230 is formed to extend to a position exceeding 180° with respect to the arbitrary tilting rotation point located in the internal space of the fixed housing 210.

Here, the inner joint 232 may be coupled to be in contact with the inner side surface of the fixed housing 210 with a frictional force that allows rotation only for an additional external force provided after the tilting rotation angle designed for the fixed housing 210 is adjusted while the antenna module A is mounted.

This is to perform a pre-stop function that prevents the arbitrary rotation unless the additional external force is provided when a worker performs a tilting rotation adjustment operation while including all of the self-load of the antenna module A.

To this end, although not illustrated in the drawing, at least one friction sealing member may be interposed between the inner joint 232 and the fixed housing 210.

Here, the friction sealing member may include at least one waterproof seal (not illustrated) installed at portions of tilting inlets 211U-T and 211D-T of the fixed housing 210 into which the inner joint 232 is inserted.

In addition, the multi-functional link assembly 200 for a small base station antenna apparatus according to the second embodiment of the present disclosure may further include at least one fixing means 219 that is fixed to penetrate through the one-sided housing cover 210U of the fixed housing 210, but is disposed to interfere with the rotation path of the inner joint 232.

Here, at least one fixing means 219 may be adopted as a headless bolt installed so that the outer end does not protrude outside the one-sided housing cover 210U of the fixed housing 210.

Therefore, a worker may stably adjust the directionality of the antenna module A by using the inner joint 232 coupled within the fixed housing 210 to have the free stop function, and then maintain the fixed state with the directivity of the antenna module A finally adjusted by using the fixing means 219 provided with the headless bolt.

In addition, in the multi-functional link assembly 200 for a small base station antenna apparatus according to the second embodiment of the present disclosure, referring to FIGS. 5A to 7, an upper drain portion 220U and a lower drain portion 220D that are connected to the internal space 212 and discharge moisture inside may be further provided on an upper outer circumferential surface and a lower outer circumferential surface of the fixed housing 210.

The upper drain part 220U and the lower drain part 220D have a moisture outlet (reference numeral not indicated), through which moisture (water) is actually discharged, formed horizontally, and a shielding end (reference numeral not indicated) that vertically shields the moisture outlet is formed, so that it is difficult for moisture such as rainwater to flow from the outside to the inside of the fixed housing 210, while moisture that once flows into the inside of the fixed housing 210 is easily discharged through the moisture outlet open in the horizontal direction.

The upper drain part 220U may be fixedly installed in an upper drain installation hole 220U-h formed in one housing cover 210U of the fixed housing 210, and the lower drain part 220D may be fixedly installed in a lower drain installation hole (reference numeral not indicated) formed in the other-sided housing cover 210D of the fixed housing 210.

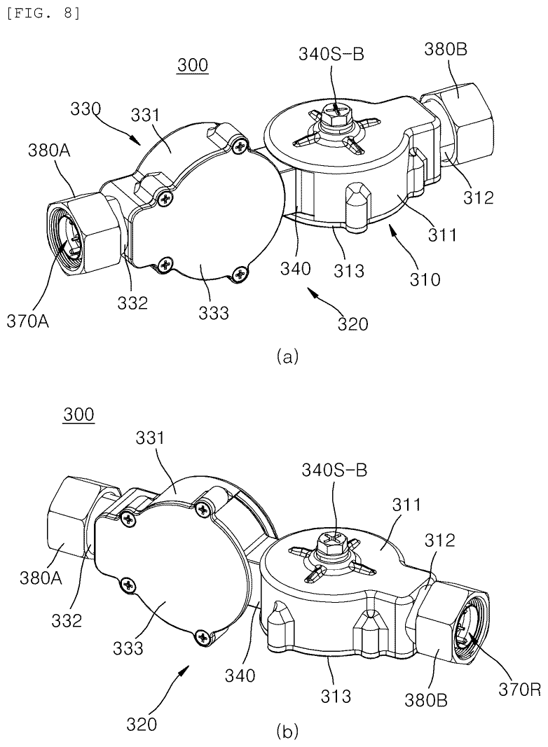

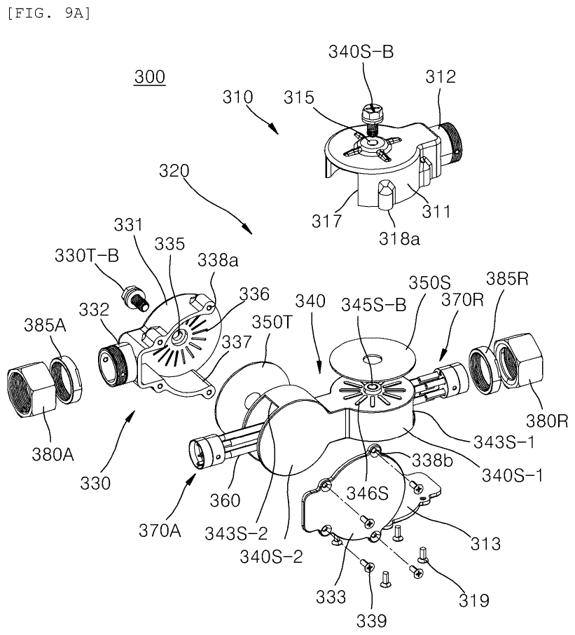

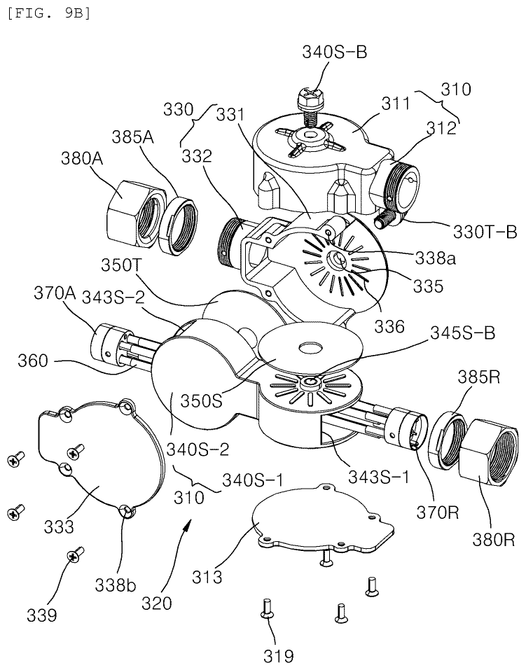

FIG. 8 is a perspective view illustrating a multi-functional link assembly for a small base station antenna apparatus according to a third embodiment of the present disclosure, and FIGS. 9A and 9B are exploded perspective views of FIG. 8.

In the multi-functional link assembly 300 for a small base station antenna apparatus according to the third embodiment of the present disclosure, referring to FIGS. 8 to 9B, a directivity adjustment means 320 may include a steering means 340 and a tilting means 330.

Here, the steering means 340 may include a steering installation part 340S-1, which is installed to rotate left and right based on a steering rotation point in the internal space of the fixed housing 310, and a steering rotation part 340S-2, which extends from the steering installation part 340S-1 to an external space (reference numeral not indicated) outside the fixed housing 310.

Referring to FIGS. 9A and 9B, the fixed housing 310 may include one-sided housing covers 311 and 312 of the fixed housing 310 where an internal space with a substantially circular horizontal cross section is formed, but is open downward to communicate with the internal space, and the other-sided housing cover 313 of the fixed housing 310 that shields the open other side of the one-sided housing covers 311 and 312.

The one-side housing covers 311 and 312 are coupled to cover the steering installation part 340S-1 from the top to the bottom, and a plurality of cover assembly screws 319 may be mutually assembled through penetration-fastening into through holes 348b and fastening holes 348a formed along an edge portion of the one-side housing covers 311 and 312 and the other-side housing cover 313.

Here, referring to FIGS. 9A and 9B, the one-side housing covers 311 and 312 may include a fixed housing body 311 having an internal space with a circular horizontal cross section, and a pipe coupling end 312 that is integrally formed to extend to the rear of the fixed housing body 311 and coupled to the cable receiving pipe (not illustrated).

A front end portion of the fixed housing body 311 may be provided with a steering guide hole 317 formed by being cut so that a steering rotation part 340S-2 of the steering means 340 can extend and protrude forward.

Meanwhile, the steering installation part 340S-1 of the steering means 340 is formed as a thin cylinder having a center point (hereinafter referred to as a ‘steering rotation point’) in the left-right horizontal direction, the steering rotation part 340S-2 of the steering means 340 is formed as a thin cylinder having a center point (hereinafter referred to as a ‘tilting rotation point’) in the up-down direction, and the steering installation part 340S-1 and the steering rotation part 340S-2 may be formed to be integrally connected in the front-back direction.

Here, a rear end of the steering installation part 340S-1 and a front end of the steering rotation part 340S-2 are provided to be mutually connected by an internal space, and a multi-strand coaxial cable 360 electrically connecting the radio unit (RRH) and the antenna module A may be provided to be installed through the internal space.

In this case, the multi-strand coaxial cable 360 may installed through the pipe connection part 312 of the fixed housing 310, and may be hidden and installed forward and backward through the rear cable installation hole 343S-1 formed by being cut in the rear end portion of the steering installation part 340S-1 and the front cable installation hole 343S-2 formed by being cut in the front end portion of the steering rotation part 340S-2.

Meanwhile, a steering guide hole 347 through which the multi-strand coaxial cable 360 penetrates and which limits the steering angle of the steering means 340 in the left-right direction may be formed in a front end portion 310S of the fixed housing body 311 in the fixed housing 310.

Similarly, in the steering rotation part 340S-2, the tilting means 330 may be coupled to tilt and rotate in the up-down direction based on the tilting rotation point.

More specifically, referring to FIGS. 9A and 9B, the tilting means 330 may include one-sided tilting housing covers 331 and 332, which are provided to cover the steering rotation part 340S-2 of the steering means 340 from one side (from the left side in the drawing) to the other side (from the right side in the drawing), and the other-sided tilting housing cover 333 that shields the open other side of the one-sided tilting housing covers 331 and 332.

Here, the one-sided tilting housing covers 331 and 332 of the tilting means 330 form an internal space with a generally circular vertical cross section, and may be formed so that the internal space is connected by being open on the other side, and the other-sided tilting housing cover 333 may be coupled to shield the open other side of the one-sided tilting housing covers 331 and 332.

The one-sided tilting housing covers 331 and 332 is coupled to cover the steering rotation part 340S-2 of the steering means 340 from one side to the other side, and a plurality of cover assembly screws 339 may be mutually assembled through the penetration of the through-hole 338b formed along the edge portion of the one-sided tilting housing covers 331 and 332 and the through-fastening hole 338a of the other tilting housing cover 333.

Here, the one-sided tilting housing covers 331 and 332 of the tilting means 330 may include a cover part 331 and an outer support part 332 that extends forward from the cover part 331 and is connected to the rear surface of the antenna module A.

Meanwhile, a tilting guide hole 337 through which the multi-strand coaxial cable 360 penetrates and limits the tilting angle of the tilting means 330 in the up-down direction may be formed in the one-sided tilting housing covers 331 and 332 of the tilting means 330.

One end of the multi-strand coaxial cable 360, which is installed through the internal space of the steering means 340, may be connected to the antenna module A while being hidden from the outside through the outer support part 332 of the one-sided tilting housing covers 331 and 332 and the tilting guide hole 337 of the one-sided tilting housing covers 331 and 332, and the other end may be connected to the radio unit (RRH) while being hidden from the outside through the steering guide hole 317 formed in the fixed housing 310 and the pipe connection part 312 of the fixed housing bodies 311 and 312.

Meanwhile, the tilting means 330 is coupled to surround the one-sided tilting housing covers 331 and 332 manufactured separately in two pieces on the outside of the steering rotation part 340S-2 and the other-sided tilting housing cover 333, and may adjust the tilting rotation of the antenna module A while rotating in the up-down direction around the tilting rotation point located in the internal space of the steering rotation part 340S-2 within the range of the tilting guide hole 337 described above.

In addition, the steering means 340 is coupled to surround the fixed housing bodies 311 and 312 of the fixed housing 310 manufactured separately in two pieces on the outside of the steering installation part 340S-1 and the other-sided housing cover 343, and may adjust the steering rotation of the antenna module A while rotating in the left-right direction around the steering rotation point located in the internal space of the fixed housing 310 within the range of the steering guide hole 317 described above.

Meanwhile, referring to FIGS. 9A and 9B, the multi-functional link assembly for a small base station antenna apparatus 300 according to the third embodiment of the present disclosure may further include a steering friction force forming pad 350S disposed between the steering installation part 340S-1 and the inner side surface of the fixed housing 310 in the steering means 340 and a tilting frictional force forming pad 350T disposed between an inner side surface of the one-sided tilting housing covers 331 and 332 in the tilting means 330 and an outer side surface of the steering rotation part 340S-2 in the steering means 340.

Here, a plurality of friction ribs 336 extending a predetermined length radially with respect to the steering rotation point and the tilting rotation point may be formed to protrude on an outer side surface of the steering installation part 340S-1 in the components of the steering means 340 facing the steering friction force forming pad 350S and inner side surfaces of the fixed housing body 311 and 312 in the components of the fixed housing 310 and an outer side surface of the steering rotation part 340S-2 in the components of the steering means 340 facing the tilting friction force forming pad 340T and inner side surfaces of the one-sided tilting housing covers 331 and 332 in the components of the steering means 340 facing the tilting friction force forming pad 340T, respectively.

Here, the steering means 340 may be fixed by the steering fixing bolt 340S-B that is fastened to the fixed housing bodies 311 and 312 that constitute the fixed housing 310 after the steering angle is adjusted within the range of the steering guide hole 313S.

More specifically, in the fixed housing body 311 and 312, the steering fixing bolt 340S-B is fastened to the housing fastening hole 315S-B formed in the upper center of the steering installation part 340S-1 by penetrating through a fixed housing through hole 345 to increase the friction between the steering friction forming pad 350S and the plurality of friction ribs (not illustrated), thereby preventing the steering rotation by any external force (such as strong wind, etc.) other than the worker's work force.

In addition, the tilting means 330 is fixed by a tilting fixing bolt 330T-B fastened to the one-sided tilting housing covers 331 and 332 constituting the tilting means 330 after the tilting angle is adjusted within a range of a tilting guide hole 313T.

More specifically, in the one-sided tilting housing covers 331 and 332 of the tilting means 330, the tilting fixing bolt 330T-B penetrates through the cover penetration hole 335 and is fastened to the cover fastening hole (not illustrated) formed in the center of the left side of the steering rotation part 340S-2 to increase the friction between the tilting friction force forming pad 350T and the plurality of friction ribs 336, thereby preventing the tilting rotation by any external force (e.g., strong wind, etc.) other than the worker's work force.

In this way, the multi-functional link assemblies 100 to 300 for a small base station antenna apparatus according to the embodiments of the present disclosure are manufactured in two pieces and combined in a form in which the outer component, which is relatively provided on the outer side, among the fixed housing 110 to 310 and the directivity adjustment means 120 to 320, surrounds the inner component, thereby providing an advantage in that it may be implemented in various embodiments.

In particular, the internal spaces of the fixed housing 110 to 310 may be hidden and installed so that all the multi-strand coaxial cables 160 to 360 are not exposed to the outside, and it provides the advantage that the plurality of antenna modules A can be installed so that various directivity adjustments are possible for the radio unit (RRH).

Unexplained drawing symbols ‘213D-h’ and ‘213U-h’ are assembly screw penetration holes for screw-fastening a one-sided housing cover 210U and the other-sided housing cover 210D, ‘219ha’ is a fixing means installation hole for inserting and installing the fixing means 219, and ‘280A’, ‘380A’, and ‘380R’ are one of the antenna side fixing nut and the radio unit side fixing nut.

Hereinabove, the small base station antenna apparatus 100 to 300 according to the embodiments of the present disclosure has been described in detail with reference to the attached drawings. However, it should be taken for granted that the embodiments of the present disclosure are not necessarily limited by the above-described embodiments, and various modifications and implementation within the equivalent range are possible by those skilled in the art to which the present disclosure belongs. Therefore, it will be said that the true scope of the present disclosure is determined by the claims described later.

### INDUSTRIAL APPLICABILITY

The present disclosure provides a multi-functional link assembly for a small base station antenna apparatus that easily builds a small cell base station in places such as public places, densely populated areas, large shopping malls, and empty buildings.

1. A multi-functional link assembly for a small base station antenna apparatus, comprising:
a fixed housing having an internal space open in one direction and the other direction; and
a directivity adjustment means movably coupled to the internal space of the fixed housing or an external space corresponding to the outside thereof,
wherein the directivity adjustment means is coupled to the fixed housing such that the directivity adjustment means is caught when an antenna module provided at a front end portion is rotationally steered left or right or rotationally tilted up or down, and thus is prevented from being separated.

2. The multi-functional link assembly of claim 1, wherein the antenna module is coupled in the one direction of the fixed housing via the directivity adjustment means, and
a radio unit is coupled in the other direction of the fixed housing via a cable receiving pipe in which a plurality of coaxial cables are hidden and received.

3. The multi-functional link assembly of claim 2, wherein a pair of housing covers is manufactured as two pieces and coupled in a form in which an outer component provided relatively on an outer side of the fixed housing and the directivity adjustment means surrounds an inner component.

4. The multi-functional link assembly of claim 3, wherein the directivity adjustment means moves around an arbitrary tilting rotation center point (hereinafter, abbreviated as ‘tilting rotation point’) and an arbitrary steering rotation center point (hereinafter, abbreviated as ‘steering rotation point’) formed in the internal space of the fixed housing, and fixes a front surface of the antenna module at a predetermined angle with respect to the radio unit.

5. The multi-functional link assembly of claim 4, wherein the directivity adjustment means includes at least one of:
a steering means adjusting the steering rotation of the antenna module while rotating left and right around a steering rotation point provided in an up-down direction via the fixed housing; and
a tilting means adjusting the tilting rotation point of the antenna module while tilting and rotating in a front and rear direction around the tilting rotation point provided in a left-right direction via the fixed housing.

6. The multi-functional link assembly of claim 5, wherein the directivity adjustment means includes the steering means and the tilting means, and
the steering means and the tilting means are integrated into a ball joint part that is partially inserted and rotated between a one-side housing cover and the other-sided housing cover of the fixed housing manufactured in two pieces.

7. The multi-functional link assembly of claim 6, wherein a friction stopper ring that prevents the separation of the ball joint part and is in close contact with a friction sealing member formed on an outer circumferential surface of the ball joint part is interposed between the one-sided housing cover and the other-sided housing cover.

8. The multi-functional link assembly of claim 5, wherein the directivity adjustment means includes the tilting means, and
the tilting means includes an inner joint that is partially inserted and rotated between a one-sided housing cover of the fixed housing and the other-sided housing cover of the fixed housing manufactured in two pieces.

9. The multi-functional link assembly of claim 8, wherein the one-sided housing cover of the fixed housing is an upper housing cover positioned relatively higher, and
the other-sided housing cover of the fixed housing is a lower housing cover positioned relatively lower.

10. The multi-functional link assembly of claim 8, wherein one end portion of the cable receiving pipe is orthogonally connected to a rear end portion of the fixed housing, and
the other end portion of the cable receiving pipe is connected to the radio unit, and
the fixed housing is connected such that the front end portion steering-rotates in the left-right direction based on a center of the cable receiving pipe.

11. The multi-functional link assembly of claim 5, wherein the directivity adjustment means includes the steering means and the tilting means,
the steering means includes a steering installation part rotationally installed in the internal space of the fixed housing in the left-right direction based on the steering rotation point, and a steering rotation part extending from the steering installation part to the external space outside the fixed housing, and
the tilting means includes a one-sided tilting housing cover provided to cover the steering rotation part from one side to the other side, and the other-sided tilting housing cover shielding the open other side of the one-sided tilting housing cover.

12. The multi-functional link assembly of claim 11, wherein the directivity adjustment means further includes:
a steering friction force forming pad arranged between the steering installation part of the steering means and the fixed housing; and
a tilting friction force forming pad arranged between the one-sided tilting housing cover of the tilting means and the steering rotation part of the steering means, and
a plurality of friction ribs extending radially to a predetermined length based on the steering rotation point and the tilting rotation point are formed protruding on an inner side surface of the fixed housing in contact with both surfaces of the steering friction force forming pad and the tilting friction force forming pad, an outer side surface of the steering installation part, and an inner side surface of the one-sided tilting housing cover of the tilting means.

13. The multi-functional link assembly of claim 11, wherein a plurality of coaxial cables electrically connecting the radio unit and the antenna module are provided to be installable in an internal space between a rear end of the steering installation part and a front end of a steering rotation part,
a steering guide hole is formed in the front end portion of the fixed housing through which the plurality of coaxial cables penetrate and which limits a steering angle of the steering means in the left-right direction, and
a tilting guide hole through which the plurality of coaxial cables penetrate and which limits a steering angle of the steering means in front and rear directions is formed in a rear end portion of the one-sided tilting housing cover of the tilting means.

14. The multi-functional link assembly of claim 13, wherein after the steering angle is adjusted within a range of the steering guide hole, the steering means is fixed by a steering fixing bolt fastened to the fixed housing.

15. The multi-functional link assembly of claim 13, wherein after the tilting angle is adjusted within a range of the tilting guide hole, the tilting means is fixed by a tilting fixing bolt fastened to the one-sided tilting housing cover.
